(19) United States
(12) Patent Application Publication
(10) Pub. No.: US 2017/0232825 A1
(43) Pub. Date: Aug. 17, 2017

(54) Sunshade For A Roof In A Vehicle, Vehicle Including The Sunshade, Method For Sun Shading In A Vehicle

(71) Applicant: Falk-Porsche-Technik GmbH, Munich (DE)

(72) Inventors: Aziza U. Ismailova, Munich (DE); Ulugbek Ismailov, Munich (DE)

(21) Appl. No.: 15/430,751

(22) Filed: Feb. 13, 2017

(30) Foreign Application Priority Data
Feb. 12, 2016 (DE) 102016001687.6

(51) Int. Cl. B60J 7/00

(52) U.S. Cl. CPC B60J 7/0007; B60J 7/0015; B60J 7/003

(57) ABSTRACT

A sunshade for a roof in vehicle, a vehicle, and a method for sun shading in a vehicle are provided. The sunshade includes a freely positionable sunshade element for the partial blocking of sunlight, which by sliding in a translucent opening in the roof can be positioned in such a manner that dazzling a person in the vehicle by sunlight irradiating through the opening can be prevented.

### FIELD OF THE INVENTION

The present invention relates to a sunshade and a method for sun shading in a vehicle, for example, a passenger car, in particular for a roof in the vehicle, and the vehicle.

### BACKGROUND OF THE INVENTION

EP1 258 379 A2 discloses a sunroof assembly for a vehicle including a roof having a sunroof opening; a headliner adjoining the roof; a track assembly disposed between the roof and the headliner, the track assembly having laterally aligned, spaced apart guide parts, and a sunshade receptacle disposed between the guide parts; and a flexible sunshade movable between an open and a closed position, the elastic sunshade in the closed position covering at least one section of the opening and in the open position being accommodated in the sunshade receptacle, the elastic sunshade having two elastic, diametrically opposed sunshade members, each of the flexible diametrically opposed sunshade members being accommodated in a sunshade reception, and the two elastic, diametrically opposed sunshade parts being movable between the open and the closed position in a direction parallel to the guide parts.

DE 10 2013 009 083 A1 discloses a roof module for a vehicle roof of a passenger car, having at least two translucent areas to which respective sunshade members are assigned, which with the aid of an actuating device are movable between an open position and a shading position at least partially covering the respectively assigned area, the sunshade elements being adjustable with the aid of a common actuator of the actuating device.

### SUMMARY OF THE INVENTION

It is an object of the present invention to improve the safety and/or the comfort of vehicles.

The devices and methods according to the present invention having the features of the independent claims have the advantage that a dazzle effect from sunlight can be reduced or eliminated.

The sunshade for a roof in a vehicle according to the present invention includes a positionable sunshade element for the partial blocking of sunlight, which by sliding in a translucent opening in the roof can be positioned in such a manner that dazzling a person or people in the vehicle by sunlight irradiating through the opening can be prevented or at least reduced. The irradiation of sunlight through the roof may vary as a function of the position of the sun and/or the angle of incidence of the sunlight. The slidability of the sunshade element thus enables a dazzle protection effect and enables a blocking of irradiation of sunlight in the area of a person located in the vehicle without that the irradiation of sunlight into the vehicle in this instance is completely prevented. The person may be a driver of the vehicle. The preventing of dazzling by sunlight thus may improve the safety of the vehicle or of the vehicle operation. The person may be another occupant of the vehicle, for example, a passenger. Thus, the preventing of dazzling by sunlight may furthermore improve the comfort of the vehicle. In this instance, the area of the sunshade element may be between 10% and 50%, for example between 20% and 40%, preferably between 25% and 35%, such as 30% of the area of the opening. In so doing, a coordination between the irradiation of sunlight and the effect of the sunshade may be affected. In particular, the sunshade element is configured in a panel-like and dimensionally stable manner. Thus, the stability of the sunshade element can be increased and simultaneously have an extremely space-saving design, which requires only very narrow side tracks for guiding the sunshade element. In particular, the sunshade element is flatly configured, that is, having a thickness of less than 7 mm, preferably 5 mm or less, and furthermore preferably even less than 3 mm or less.

Furthermore, the sunshade according to the present invention can include a further sunshade element which, by itself for in combination with the sunshade element, can completely seal the opening against irradiating sunlight. Thus, an irradiation of sunlight through the roof into the interior of the vehicle can be prevented. In so doing, a complete dimming of the interior from sunlight irradiating through the opening can be achieved.

The further sunshade element can be slidably configured. In so doing, the further sunshade element, for example, may be configured in a panel-like or shield-like manner. Thus, the stability of the further sunshade element can be increased. In this instance, a reduction or increase of the effective light-blocking area may take place by sliding the sunshade element under a translucent further vehicle part. The further sunshade element can be configured in a rollable manner. For this purpose, the light-blocking area of the further sunshade element may be reduced by rolling up the sunshade element or enlarged by unrolling the sunshade element. In this instance, the further sunshade element may be configured in a particularly space-saving manner. The modification of the area of the further sunshade element enables the person located in the vehicle to adapt the light conditions to a respective situation. Preferably, the sunshade element furthermore may be moved by sliding it under the further sunshade element.

The sunshade according to the present invention can be configured in such a manner that it can be disposed in an open roof, a sunroof, a glass roof or a panoramic roof. In this instance, the sunshade element and/or the further sunshade element may be configured as elements of the roof, for example, of the sunroof. In so doing, the sunshade according to the present invention may be used in different roof variations of the vehicle. Being able to use the sunshade in different roof variations of the vehicle enables to adapt the irradiation of sunlight through the opening in the roof depending on the weather, because the sunshade is equally usable in warm outside temperatures having an open roof and in cold outside temperatures having a closed translucent roof.

The slidable sunshade element may be manually positioned. For this purpose, the sunshade element can be configured in a manner to be directly slidable by manual motion. This enables the person located in the vehicle to directly determine the position of the sunshade element. In so doing, the sunshade according to the present invention may be realized in a particularly simple and/or cost-effective manner. Furthermore, the sunshade according to the present invention may be installed retroactively in the roof of the vehicle in a particularly simple and/or cost-effective manner.

The slidable sunshade element may be positioned with the aid of a switch element. Thus, the slidable sunshade element, for example, may be slidable by a manual switch actuation. This enables the person located in the vehicle to comfortably determine the position of the sunshade element. In this instance, the switch element, for example, may be connected to an actuator of the sunshade element or be connected to the actuator via a control device, for example, a control device of the vehicle.

Furthermore, the sunshade according to the present invention may include a light sensor for the detection of irradiating sunlight, the slidable sunshade element being positioned as a function of the detected sunlight. This enables an automatic alignment of the slidable sunshade element without the influence of the person located in the vehicle.

The light sensor can be disposed in the vehicle in such a manner that the sunlight can be detected in the area of a person in the vehicle. In so doing, the automatic alignment of the slidable sunshade element can be improved.

Furthermore, the light sensor may be disposed at a head rest of the vehicle, for example, at a head rest of a driver seat. In so doing, the light sensor may be disposed in the area of the interior where the sunlight irradiated through the opening in the roof is to be determined.

Furthermore, the present invention relates to a vehicle including the sunshade according to the present invention.

The method for sun shading in a vehicle according to the present invention includes to provide a positionable sunshade element for the partial blocking of sunlight, which by sliding in a translucent opening in the roof of the vehicle can be positioned in such a manner that dazzling a person in the vehicle by sunlight irradiating through the opening can be prevented.

Furthermore, the method according to the present invention can include to provide a further sunshade element, which in combination with the sunshade element can completely seal the opening against irradiating sunlight.

For this purpose, the further sunshade element may be configured in a slidable or rollable manner.

Furthermore, the sunshade can be configured in such a manner that it can be disposed in an open roof, a sunroof, a glass roof or a panoramic roof.

The slidable sunshade element may be configured to be manually positionable.

The slidable sunshade element may be configured to be manually positionable with the aid of a switch element.

Furthermore, the method according to the present invention can include to provide a light sensor for the detection of the irradiating sunlight.

In this instance, the light sensor can be disposed in the vehicle in such a manner that the sunlight can be detected in the area of a person in the vehicle.

Furthermore, the light sensor may be disposed at a head rest of the vehicle, for example, at a head rest of a driver seat.

### DESCRIPTION OF PREFERRED EMBODIMENTS

Preferred exemplary embodiments of the present invention are shown in the drawing and explained in greater detail in the subsequent description.

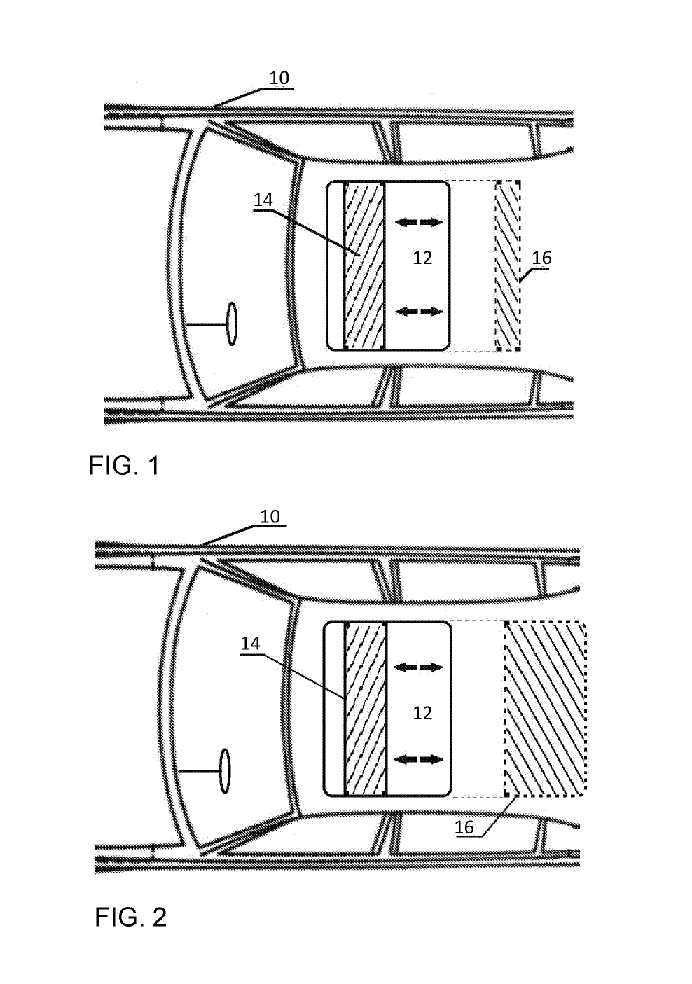

FIG. 1 shows a schematic illustration of a sunshade according to an embodiment of the present invention integrated in a roof of a vehicle 10;

FIG. 2 shows a schematic illustration of a sunshade according to a further embodiment of the present invention integrated in a roof of a vehicle 10;

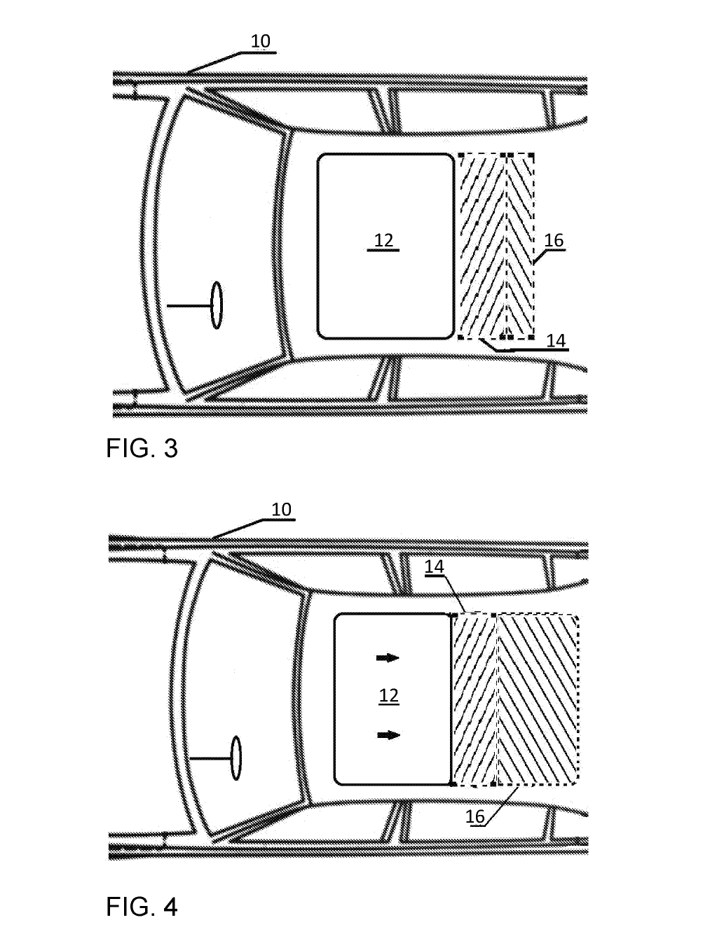

FIG. 3 shows a further schematic illustration of the sunshade according to the embodiment of the present invention integrated in the roof of vehicle 10;

FIG. 4 shows a further schematic illustration of the sunshade according to the further embodiment of the present invention integrated in the roof of vehicle 10;

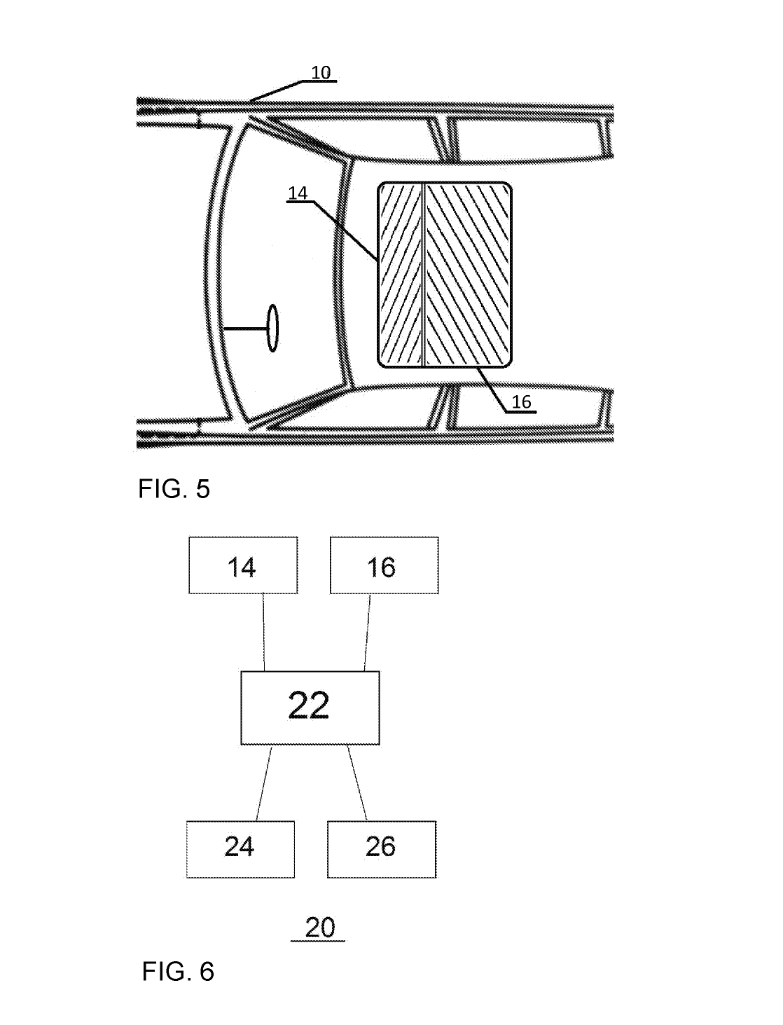

FIG. 5 shows another schematic illustration of the sunshade according to the further embodiment of the present invention integrated in the roof of a vehicle 10; and

FIG. 6 shows a schematic illustration of a sunshade 20 according to another embodiment of the present invention.

By providing a sunshade according to the present invention, dazzling a person located in vehicle 10 can be prevented.

FIG. 1 shows a schematic illustration of a sunshade according to an embodiment of the present invention integrated in a roof of a vehicle 10.

The sunshade includes a slidable sunshade element 14. Slidable sunshade element 14 is configured in a panel-like and dimensionally stable manner. For example, it may be disposed in guide tracks, which are attached at an interior side of the roof. Slidable sunshade element 14 is located in the area of an opening 12 in the roof and is, as shown in FIG. 1, freely positionable in opening 12. Thus, dazzling a person, for example a driver of vehicle 10, by sunlight irradiating through opening 12 may be prevented.

Sunshade element 14 is positioned in opening 12 of the roof in vehicle 10 in such a manner that it may partially block irradiating sunlight by sliding in translucent opening 12 and the dazzling of the person in the vehicle may be prevented. For this purpose, sunshade element 14 is preferably inserted into the lateral guide tracks, within which sunshade element 14 is slidable. The positionability of sunshade element 14 ensures a dazzle protection effect independent from the angle of incidence of the sunlight through the roof and enables a blocking of irradiation of sunlight in the area of a person located in vehicle 10 without that the irradiation of sunlight or the penetration of fresh air into vehicle 10 in this incidence is completely prevented.

Preferably, the area of sunshade element 14 is between 10% and 50% of the total area of two sunshade elements 14 and 16, particularly preferably between 20% and 40% of two sunshade elements 14 and 16 and especially particularly preferably between 25% and 35%, such as 30% of the total area of two sunshade elements 14 and 16. In the preferred embodiment, the sunshade element is solidly configured, thus, configured as a solid material. For example, the sunshade element may be carried out in the form of a plastic panel. The thickness of such panels is preferably at most 7 mm or less, 5 mm or less or 3 mm or less.

Furthermore, sunshade element 14 may be modifiable in surface area, for example by additional roller blind-like elements which can be pulled out from the sunshade element and which expand the surface area of the sunshade element. Another possibility is provided by disposed auxiliary panels of a telescopic or stack type, which may be extended or retracted or pulled apart and pushed together from or under sunshade element 14 to so enlarge or diminish the surface area of the sunshade. The telescopic-type configuration is particularly suited for solidly formed, flat panels.

The sunshade may include a further sunshade element 16. Further sunshade element 16 may be configured as a type of a roller blind or in a rollable manner; however, it may also be configured in the form of a panel. As shown in FIG. 1, further sunshade element 16 is located under a translucent part of the roof and is rolled up or can there be inserted.

Further sunshade element 16, by itself or in combination with first sunshade element 14, can completely seal opening 12 against irradiating sunlight. In this instance, two sunshade elements 14 and 16 are preferably located in the same lateral guide tracks. Then, sunshade element 14 and additional sunshade element 16 together can completely cover opening 12 in the roof. The guide tracks for further sunshade element 16 can however also be provided in addition to guide tracks for sunshade elements 14, so that for example a conventional cover on the inside of the sunroof can completely seal the opening in the roof and sunshade element 14 is only used if further sunshade element 16 has at least partially been moved out of opening 12. Further sunshade element 16 is preferably disposed in a rear area of the roof and can be diminished by rolling up its light-blocking surface area or enlarged by unrolling the surface area. The modification of the area of further sunshade element 16 enables the person located in the vehicle to adapt the light conditions to a respective situation.

The sunshade according to the present invention is insertable into all roof variations of vehicle 10 and may be used in an open roof, for example a sunroof exposing the roof opening or a folding roof, as well as in a covered, translucent roof, for example a panoramic glass roof or another translucent panoramic roof. This enables to ideally adapt the irradiation of sunlight through opening 12 in the roof depending on the weather, because the sunshade is equally usable in warm outside temperatures having an open roof and in cold outside temperatures having a closed, translucent roof.

FIG. 2 shows a schematic illustration of a sunshade according to a further embodiment of the present invention integrated in a roof of a vehicle 10.

The sunshade again includes a slidable sunshade element 14. Slidable sunshade element 14 is configured in a panel-like and dimensionally stable manner. For example, it may be disposed in guide tracks, which are attached at an interior side of the roof.

The sunshade can include a further sunshade element 16 which, in particular, is also freely positionable. Further sunshade element 16 is also configured in a panel-like and dimensionally stable or in a roller blind-type manner. It also can be disposed in the guide tracks. As shown in FIG. 1, further sunshade element 16 is located under a translucent part of the roof. Further sunshade element 16 is again preferably disposed in a rear and/or front area of the roof and, by sliding under the translucent part of the roof, it may be modified in its light-blocking surface area. For this purpose, elements 14 and 16 are positionable independently from each other. The elements can be guided in the same guide tracks in the longitudinal or transverse direction.

FIG. 3 shows a further schematic illustration of the sunshade according to the embodiment of the present invention integrated in the roof of vehicle 10 in a fully opened state.

In reference to FIG. 1, slidable sunshade element 14 is now slid under the translucent part and is located next to rolled-up further sunshade element 16, so that opening 12 in the roof is completely open.

FIG. 4 shows a further schematic illustration of the sunshade according to the embodiment of the present invention integrated in the roof of vehicle 10 in a fully opened state.

In reference to FIG. 2, slidable sunshade element 14 is now slid under the translucent part and is located next to further sunshade element 16, so that opening 12 in the roof is completely exposed.

FIG. 5 shows another schematic illustration of the sunshade according to the further embodiment of the present invention integrated in the roof of vehicle 10 in a closed state.

In reference to FIGS. 2 and 4, slidable sunshade element 14 and further sunshade element 16 are slid into opening 12 and together completely seal the opening against irradiating sunlight.

FIG. 6 shows a schematic illustration of a sunshade 20 according to another embodiment of the present invention.

Sunshade 20 includes sunshade element 14 and a switch element 24 for detecting instructions from the person and/or for operating sunshade element 14 and/or light sensor 26 for the detection of irradiating sunlight. Furthermore, sunshade 20 may include a further sunshade element 16. Sunshade 20 may furthermore include a control device 22, which is connected to sunshade element 14, switch 24, light sensor 26 and/or further sunshade element 16, for controlling or regulating sunshade 20. For this purpose, control device 22 may take into account a threshold value and/or control or regulate sunshade 20 as a function of an intensity of the irradiation of sunlight.

Slidable sunshade element 14 may be manually positioned. In this instance, sunshade element 14 can be directly slidable by a manual sliding movement and/or indirectly slidable via electric controller 22 by manually operating switch element 24. This enables a person located in the vehicle to directly determine the position of the sunshade element.

Furthermore, the sunshade according to the present invention may include light sensor 26 detecting the irradiating sunlight. In so doing, sunshade element 14 may be positioned as a function of the irradiated sunlight detected by light sensor 26 and enables an automatic alignment without the influence of a person located in the vehicle.

Light sensor 26 detecting the irradiated sunlight may be disposed in vehicle 10 in such a manner that the irradiation of sunlight can be detected in the area of a person located in vehicle 10. Preferably, light sensor 26 is attached at a head rest, particularly preferably at the head rest of a driver seat. In so doing, light sensor 26 may be disposed directly in the area of the interior in which the sunlight irradiated through the opening in the roof is to be determined.

The sunshade according to the present invention, including slidable sunshade element 14 and optionally further sunshade element 16, which, for example, can be rollable or slidable, switch device 24, light sensor 16 and/or control device 22, can be integrated in vehicle 10.

1. A sunshade for a roof in a vehicle, comprising:
a freely positionable sunshade element for partial blocking of sunlight, wherein the freely positionable sunshade element can be positioned in a translucent opening in the roof by sliding, such that dazzling a person in the vehicle by sunlight irradiating through the translucent opening can be prevented, and
a further sunshade element.

2. The sunshade as recited in claim 1, wherein the further sunshade element in combination with the freely positionable sunshade element can completely seal the opening against irradiating sunlight.

3. The sunshade as recited in claim 2, wherein the further sunshade element is slidably or rollably configured.

4. The sunshade as recited in claim 1, wherein the sunshade is configured such that it can be disposed in an open roof, a sunroof, a glass roof or a panoramic roof.

5. The sunshade as recited in claim 1, wherein the freely positionable sunshade element can be manually positioned.

6. The sunshade as recited in claim 5, wherein the freely positionable sunshade element can be positioned with the aid of a switch element.

7. The sunshade as recited in claim 1, further comprising:
a light sensor for detection of irradiating sunlight,
wherein the freely positionable sunshade element can be positioned as a function of the detected sunlight.

8. The sunshade as recited in claim 7, wherein the light sensor is disposed in the vehicle such that the sunlight can be detected in an area of a person in the vehicle.

9. The sunshade as recited in claim 8, wherein the light sensor is disposed at a head rest of the vehicle.

10. A vehicle comprising the sunshade as recited in claim 1.

11. A method for sun shading in a vehicle comprising:
providing a freely positionable sunshade element for partial blocking of sunlight, wherein the freely positionable sunshade element can be positioned in a translucent opening in the roof of the vehicle by sliding, such that dazzling a person in the vehicle by sunlight irradiating through the translucent opening can be prevented, and
providing a further sunshade element.
